(19) United States
(12) Patent Application Publication
(10) Pub. No.: US 2005/0266280 A1
(43) Pub. Date: Dec. 1, 2005

(54) Electronic apparatus system, fuel cell unit and power supply control method

(76) Inventors: Akihiro Ozeki, Ome-shi (JP); Koji Nakamura, Akiruno-shi (JP); Nobuo Shibuya, Hiratsuka-shi (JP); Hirohisa Miyamoto, Kamakura-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/084,659

(22) Filed: Mar. 18, 2005

(30) Foreign Application Priority Data
May 31, 2004 (JP) 2004-162526

(51) Int. Cl. H01M 8/04; H01M 16/00

(52) U.S. Cl. 429/13; 429/9; 429/22; 429/23

(57) ABSTRACT

A microcomputer of a fuel cell unit controls the output power of a DMFC at two stages in a High mode and in a Low mode by driving of an auxiliary machine. When an output value of a DC/DC converter exceeds a predetermined value, the microcomputer decides a rechargeable cell connected to one diode of a diode OR circuit of an electronic apparatus side with the other diode connected to the converter as being a near-full charged level and drives the auxiliary machine so as to lower an output power from a High mode to a Low mode. When, after this, a predetermined time is elapsed, the microcomputer decides the residual amount of the rechargeable cell as being lowered down to a predefined value and drives the auxiliary machine so as to return the output power from the Low mode to the High mode.

### CROSS-REFERENCE TO RELATED APPLICATIONS

This application is based upon and claims the benefit of priority from the prior Japanese Patent Application No. 2004-162526, filed May 31, 2004, the entire contents of which are incorporated herein by reference.

### BACKGROUND

1. Field

Embodiments of the present invention relate to a power supply control technique for efficiently operating, for example, a fuel cell of, for example, a direct methanol system.

2. Description of the Related Art

In recent years, a battery-drivable electronic apparatus such as a notebook type personal computer has been widely marketed. Recently, developments have been made to produce a fuel cell for an electronic device that is more environmentally friendly than prior fuel cells.

For instance, a direct methanol fuel cell, hereinafter referred to as a “DMFC,” is of such a structure where two electrodes of a porous metal or carbon are provided with an electrolyte sandwiched therebetween. Given as a fuel, methanol reacts with oxygen to produce an electrical energy from this chemical reaction. Various proposals have been made, for example, in JPN PAT APPLN KOKAI PUBLICATION NO. 5-182675 (hereinafter referred to as “publication”) so as to enhance the operation efficiency of a fuel cell of such a structure.

The technique disclosed in the publication discloses the joint use of a storage battery and fuel cell and the intermittent operation of the fuel cell at a rated output without following a load variation. That is, this technique is so designed as to improve the operation efficiency of the fuel cell while ensuring a power supply from the storage battery to a load at all times.

The DMFC is generally classified into an evaporation type and auxiliary machine type. The auxiliary machine type DMFC is applied to the notebook type personal computer, etc., and equipped with a solution supply pump, air blowing pump, etc. By controllably driving the auxiliary machine it is possible to control a power generation.

The technique disclosed in the publication uses an intermittent operation (operation at a rated output), which is not desirable in the auxiliary machine type DMFC from a standpoint of efficiency. Further, no consideration is given in this publication to any relation of the DMFC to a residual capacity of the storage battery to be used therewith.

Further, the DMFC is not power efficient unless the temperature of the cell stack structure is high. When the DMFC is operated on an ON/OFF control fashion, it takes time to effect a start-up operation in the DMFC.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing an outer appearance of an exemplary electronic apparatus system according to one embodiment of the present invention;

FIG. 2 is a view showing a circuit arrangement relating to the power supply control of an embodiment of the electronic apparatus system;

FIGS. 3A and 3B are views for explaining a power generation amount at a LOW mode and that at a High mode for an embodiment of the electronic apparatus system;

FIG. 4 is a view showing an exemplary relation of a residual capacity of a rechargeable cell and a charging voltage value at each residual capacity for an embodiment of the electronic apparatus system;

FIG. 5 is a concept diagram showing the fuel efficiency of a DMFC under conventional control;

FIG. 6 is a view showing a detail of a “heat loss” in FIG. 5 in a way to compare a “loss due to a voltage” and a “loss due to a cross-over (C.O)”;

FIG. 7 is a view for explaining a basic control concept of a DMFC on the electronic apparatus system of an embodiment of the invention;

FIG. 8 is a view showing an exemplary relation between the fuel concentration and the fuel efficiency of the DMFC;

FIG. 9 is an exemplary flowchart showing a power supply control procedure of an embodiment of the electronic apparatus system;

FIG. 10 is a view showing a setting example of a residual amount of the rechargeable cell which is so modified as to control an embodiment of the electronic apparatus system at three stages;

FIG. 11 is a view showing a setting example of an output voltage of the DMFC which is so modified as to control an embodiment of the electronic apparatus system at three stages; and

FIG. 12 is an exemplary flowchart showing a control procedure, which is so modified as to control an embodiment of the electronic apparatus system at three stages.

### DETAILED DESCRIPTION

With reference to the drawing, an explanation will be made about the embodiment of the present invention.

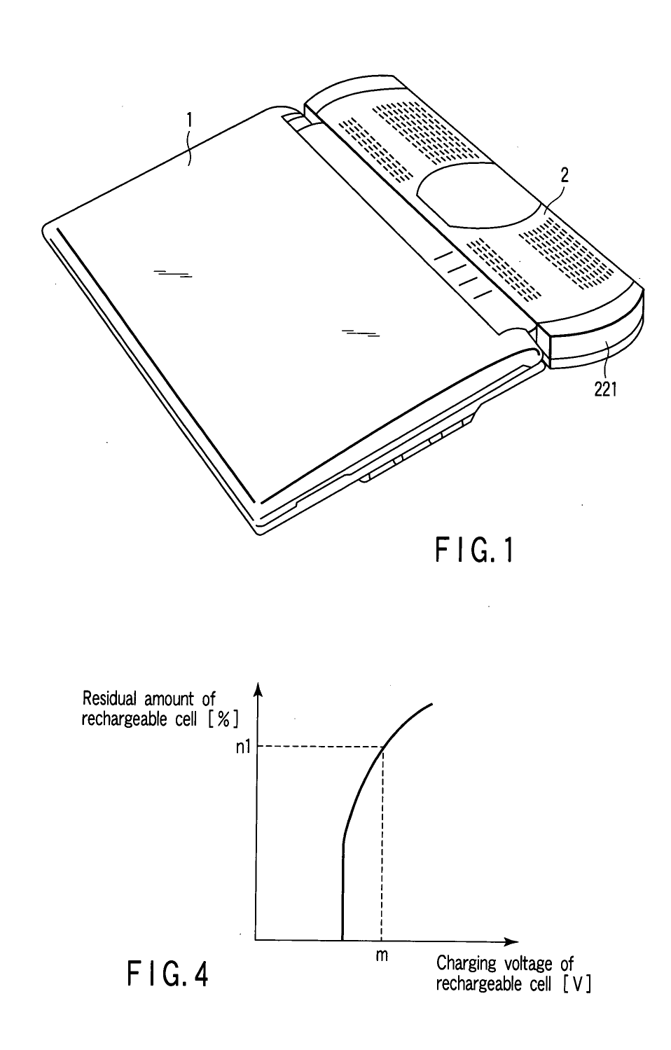

FIG. 1 shows an outer appearance of an electronic apparatus system according to one embodiment of the present invention. The electronic apparatus system comprises an electronic apparatus 1 and a fuel cell unit 2 detachably attached to the electronic apparatus 1.

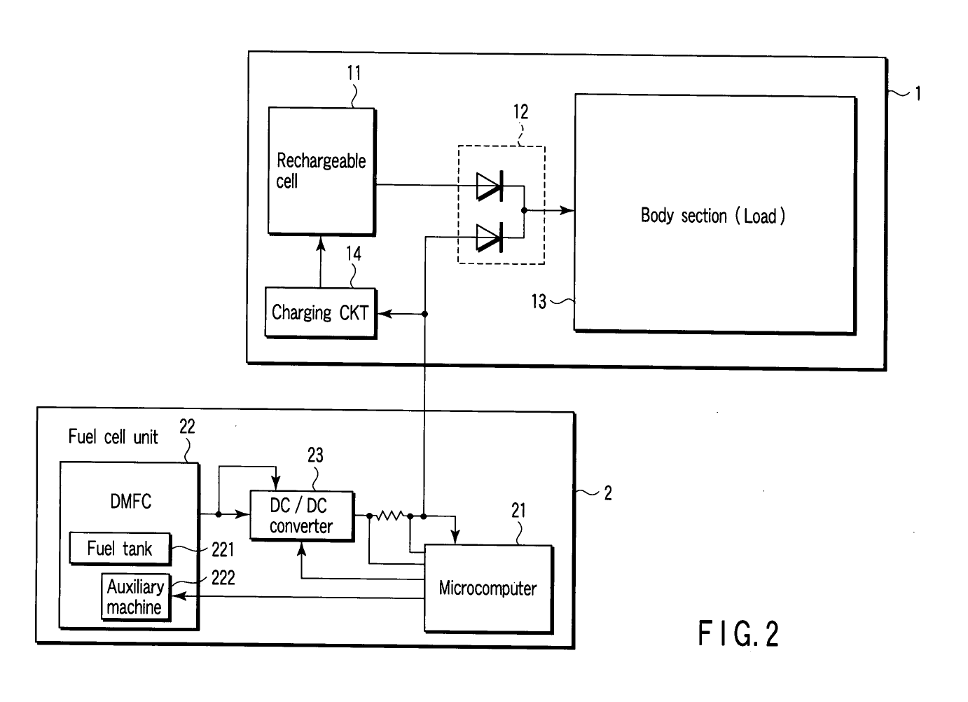

As shown, the electronic apparatus 1 is a so-called notebook type personal computer and can be operated by a power energy supplied from the fuel cell unit 2. The fuel cell unit 2 is of a direct methanol type such that a power generation occurs due to a reaction of the methanol with the air (oxygen). The fuel cell unit 2 is equipped with a cartridge type fuel tank 221 (shown in FIG. 2) which can be detachably connected to the fuel cell unit 2. The fuel methanol is stored in the fuel tank 221. Of course, other liquid fuels besides methanol may be used by the electronic apparatus system without departing from the spirit and scope of the invention.

FIG. 2 shows a schematic arrangement relating to the power supply control on the electronic apparatus system.

The fuel cell unit 2 includes a control unit 21 (e.g., a microcomputer as described for illustrative purposes or perhaps a microcontroller or a processor). Under the control of the microcomputer 21, the power generation is done by the DMFC 22. The DMFC 22 has a reaction section called a “cell stacked section” where the methanol stored in the fuel tank 221 is reacted with the air to effect the power generation. An auxiliary machine 222 is also provided in the DMFC 22 to send the methanol and the air to the reaction section. The microcomputer 21 controllably drives the auxiliary machine 222 to control an amount of power generated in the DMFC 22.

The output power of the DMFC 22 is supplied to a DC/DC converter 23, where it is converted to a voltage indicated by a microcomputer 21. The output power of the DC/DC converter 23 is supplied to one diode of a diode OR circuit 12 in the electronic apparatus 1 while, on the other hand, the output of a rechargeable cell 11, such as a lithium ion cell, in the electronic apparatus 1 is supplied to the other diode of the diode OR circuit 12.

Where the load power of a body section 13 in the electronic apparatus 1 is smaller than the current power generation amount of the DMFC 22, the microcomputer 21 sets the output voltage of the DC/DC converter 23 higher than that of the rechargeable cell 11, so that the supply of the power is done from the DMFC 22. If, on the other hand, the load power of the body section 13 is larger than the current power generation amount of the DMFC 22, the microcomputer 21 sets the output voltage of the DC/DC converter 23 in balance with that of the rechargeable cell 11. By doing so, the DC/DC converter 23 is so driven under the control of the microcomputer 21 so as to supply the power not only from the DMFC 22 but also from the rechargeable cell 11.

In the electronic apparatus 1, a charging circuit 14 is provided for charging the rechargeable cell 11. Where the load power of the body section 13 side is lower than the power supplied from the fuel cell unit 2 side, the charging circuit 14 charges the rechargeable cell 11, as a floating charge, with its surplus power.

That is, according to the electronic apparatus system, where any surplus power occurs at the output of DMFC 22, it is charged in the rechargeable cell 11, while, on the other hand, where any deficiency output occurs at the output of the DMFC 22, the rechargeable cell 11 is discharged to compensate for the deficiency portion. Under this consideration, the microcomputer 21 controllably drives the auxiliary machine 222 so as to control the power generation level of the DMFC 22 as set out below.

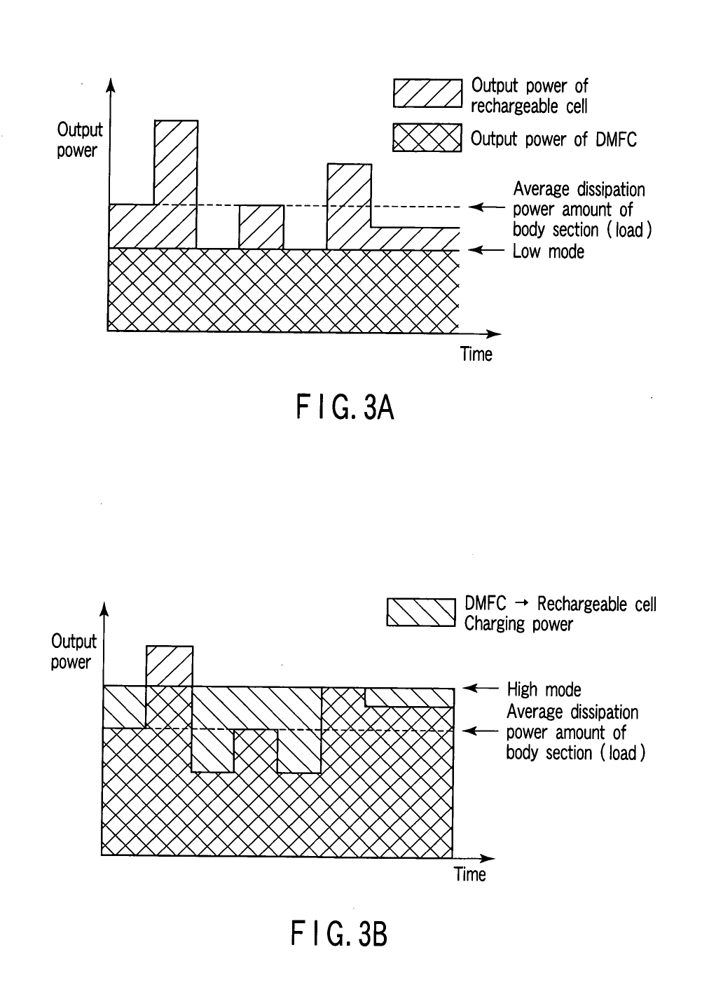

First, the microcomputer 21 controls the DMFC 22 at two stages; at a Low mode and at a High mode. A power generation amount at the Low mode and that at the High mode are set as shown in FIGS. 3A and 3B.

That is, the power generation amount at the Low mode is set to be lower than an average of load power energies on the body section 13 side statistically calculated for each model of respective systems (FIG. 3A). The power generation amount at the High mode is set to be higher than the average mentioned above (FIG. 3B). As a result, at the Low mode time, the rechargeable cell 11 has a tendency to be discharged while, at the High mode time, the rechargeable cell 11 has a tendency to be charged.

Second, the microcomputer 21 performs mode switching operations on the DMFC 22 so as to correspond to a residual amount of the rechargeable cell 11. When the residual capacity of the rechargeable cell 11 exceeds n1% near its full capacity, then the microcomputer 21 switches the DMFC 22 from the High mode to the Low mode to lower the power generation amount. If, after this, the residual capacity is reduced down to n2% where the system ensures an operation to be done at a time over a defined time with a power supply energy of the rechargeable cell only, then the microcomputer 21 returns the DMFC 22 from the Low mode to the High mode.

Based on the following principle, the microcomputer 21 in the fuel cell 2 decides whether or not the residual amount of the rechargeable cell 11 in the electronic apparatus 1 exceeds n1%. FIG. 4 shows a relation between the residual amount of the rechargeable cell 11 and the charging voltage value at each residual amount. As set out above, the floating charging is performed on the rechargeable cell 11 with the use of an output power of the DC/DC converter 23. Where the output voltage of the DC/DC converter 23 exceeds a predetermined voltage level (m[V]), the microcomputer 21 decides the residual amount of the rechargeable cell 11 as exceeding n1%. After the DMFC 22 has been switched from the High to the Low mode, the microcomputer decides whether or not the residual amount of the rechargeable cell 11 is reduced down to n2% and this is done so while monitoring an elapsed time from its switching time.

That is, if a predetermined time is elapsed, that is, a time at which the residual capacity of the rechargeable cell 11 at a Low mode time statistically calculated for each model of the respective systems can be estimated to be lowered from n1% down to n2% is elapsed, then the microcomputer 22 decides the residual amount of the rechargeable cell 11 as being lowered down to n2%. The terms “n1” and “n2” are predetermined percentages.

That is, where a first condition is established under which the output voltage of the DC/DC converter 23 exceeds an m[V], the microcomputer 22 decides the residual amount of the rechargeable cell 11 as exceeding the n1% and switches the DMFC 22 from the High mode to the Low mode. After this, if a second condition is established under which a predetermined time is elapsed from that time point, the microcomputer decides the residual amount of the rechargeable cell 11 as being lowered down to n2%. and returns the DMFC 22 from the Low mode to the High mode.

With reference to FIGS. 5 to 8, an explanation will be made below about the reason why the DMFC 22 is controlled at two stages in the High and Low modes as set out above.

FIG. 5 is a concept diagram graphically showing the fuel efficiency of the DMFC 22 in the conventional control, the abscissa indicating an output power and the ordinate indicating a detail of a fuel energy consumed at a time involved, that is, indicating a portion utilized as the power and a “heat loss” portion generated in the fuel cell device. In this example, the parameters such as the flow rate of a fuel solution are maintained at a constant value and are not so optimized as to correspond to the output power involved.

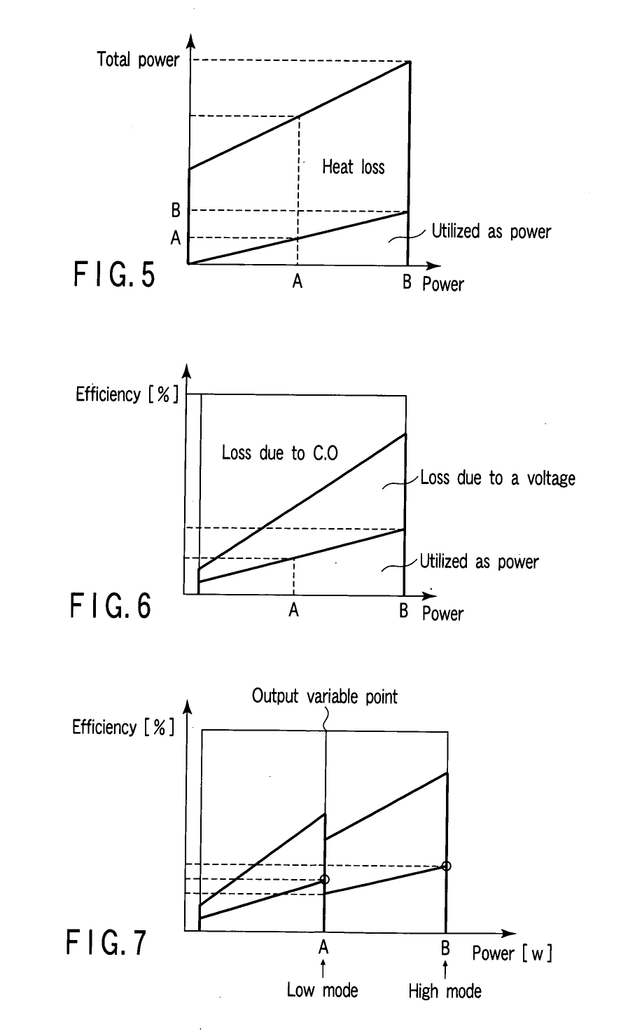

FIG. 6 shows a detail of the “heat loss” indicating a “loss due to a voltage” and a “loss due to a cross-over” (C.O). Here, the term cross-over shows that the fuel methanol is moved past a solid polymer film in the fuel cell structure toward an opposite side (oxidation pole). It is known that there occurs a problem, that is, a catalyst on the oxidation side is inactivated (poisoned) and the resultant crossed-over fuel is oxidized on the oxidation pole side. The fuel is all converted to heat and does not contribute to the power generation at all, so that this causes a lowering in fuel efficiency. Here, the ratio between the fuel amount ineffectively consumed at the oxidation pole side due to such cross-over and the fuel amount supplied to the fuel pole side is called as a cross-over ratio.

In FIG. 6, the abscissa indicates the same as that of FIG. 5 and, for easiness in comparison, the ordinate indicates the efficiency (corresponding to the normalization of the graph of FIG. 5 with a total electric power). It is to be noted that the voltage loss here means an electric power loss caused by a reverse voltage resulting from a decrease of an anode/cathode voltage in the cell structure in comparison with a theoretical value and corresponding to an electric power dissipated due to an internal resistance in the fuel cell.

As evident from FIG. 6, the loss caused by cross-over is a major cause for lowering the efficiency involved. Moreover, this loss is the lowest when the cell is fully operated at a rated output and is largely increased as the output power becomes smaller than at the rated level. In the electronic apparatus system of the present embodiment, therefore, the control of the DMFC 22 is affected as shown in FIG. 7.

First, basically, the DMFC 22 is operated at a rated power of B[W]—High mode. If it is designed based on this basic concept, it follows that, with the operation of the DMFC, the rechargeable cell 11 of the electronic apparatus 1 is brought nearer to a full charge level. From this viewpoint, the DMFC 22 is so designed as to be operable even at a second operation point (an output variable point in FIG. 7) far smaller in output level than at the rated power level-Low mode. Here it is assumed that this point is set to, for example, one half the rated output level-A[W]. When the rechargeable cell 11 of the electronic apparatus 1 is brought nearer to a full charge (over n1%), the DMFC 22 is operated at this second operation point and, if the rechargeable cell 11 of the electronic apparatus 1 is brought adequately away from the fill charge level (below n2%), then the DMFC 22 is returned again back to a basic operation.

If, respectively at the rated output time (B[W]) and at the second operation point (A[W]), various parameters of the DMFC 22 are designed to optimal values, the efficiency at the “output variable point” in FIG. 7 is largely improved over the efficiency at the operation point in FIG. 5. The main causes are a decrease in fuel concentration, a decrease in fuel flow amount and a decrease in air flow amount. By doing so, it is possible to lower the cross-over rate and decrease the dissipation power in the auxiliary machine in order to improve efficiency.

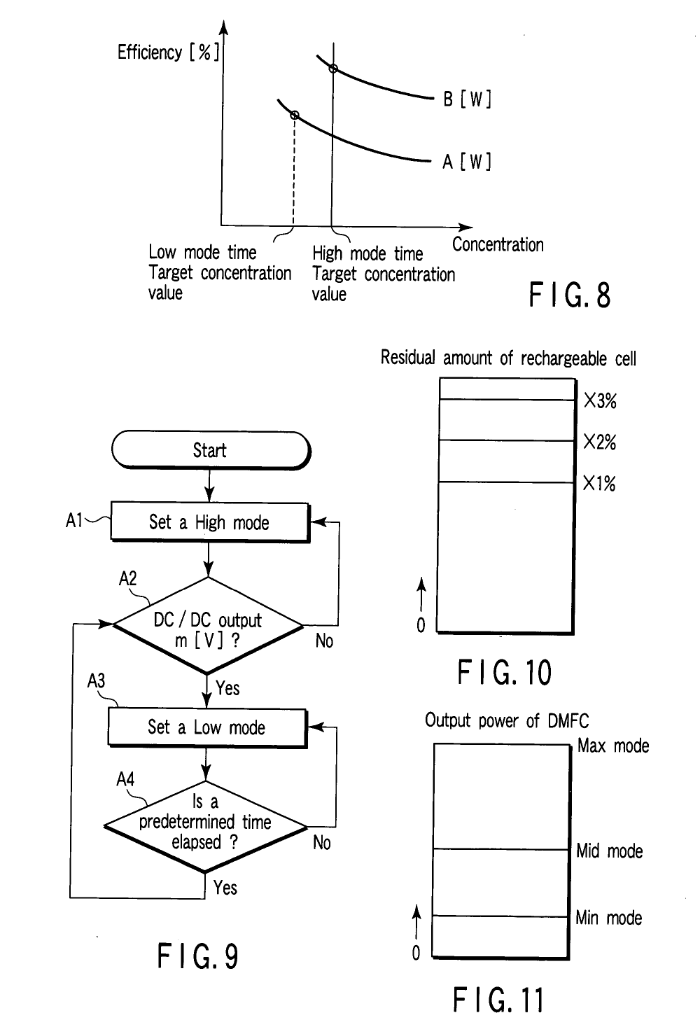

Furthermore, it is possible to improve the fuel cell by performing an operation with the operation points fixed to two previously optimized points. FIG. 8 is a view showing a relation between the fuel concentration and the fuel efficiency. Even if simple control is to be performed, for example, with the fuel concentration set to a constant level during a steady-state operation, it is possible to improve the fuel efficiency since a target concentration can be varied in accordance with each operation point.

FIG. 9 is an exemplary flowchart showing a power supply control procedure of this electronic apparatus system. The microcomputer 21 of the fuel cell unit 22 first controls the driving of the auxiliary machine 222 so as to set the DMFC 22 to a High mode (operation A1). Then, the microcomputer 21 checks whether or not a residual amount of the rechargeable cell 11 in the electronic apparatus 1 exceeds no, that is, the output voltage of the DC/DC converter 23 exceeds m[V] (operation A2). If YES (YES in operation A2), the microcomputer control the driving of the auxiliary machine 222 so as to set the DMFC 22 to a Low mode (operation A3).

After the setting of the Low mode, the microcomputer 21 checks whether or not the residual amount of the rechargeable cell 11 in the electronic apparatus 1 becomes lower than n%, that is, a predetermined time is elapsed from that mode setting (operation A4). If YES (YES in operation A4), control goes back to operation A1 and the microcomputer 21 controls the driving of the auxiliary machine 222 so as to set the DMFC 22 to a High mode.

Although the setting of the two operation points has been explained, this method of improving the operation efficiency of the DMFC 22 in cooperation with the rechargeable cell 11 is not restricted to the setting of the two operation points and it is of course possible to set three or more operation points for multi-stage control.

As shown in FIG. 10, for example, three values x1%, x2% and x3% (x1≦x2≦x3, “x” being a positive integer) may be adopted as a reference value of a residual amount of the rechargeable cell 11 and, based on this, the DMFC 22 is controlled at three stages of a Max mode, Mid mode and Min mode as shown, for example, in FIG. 11. Further, as the rechargeable cell's residual amount deciding method, there are several methods available, for example, the monitoring of the output voltage of the DC/DC converter 23, the monitoring of an elapsed time after the mode setting, and the giving of a notice from the electronic apparatus 1 side.

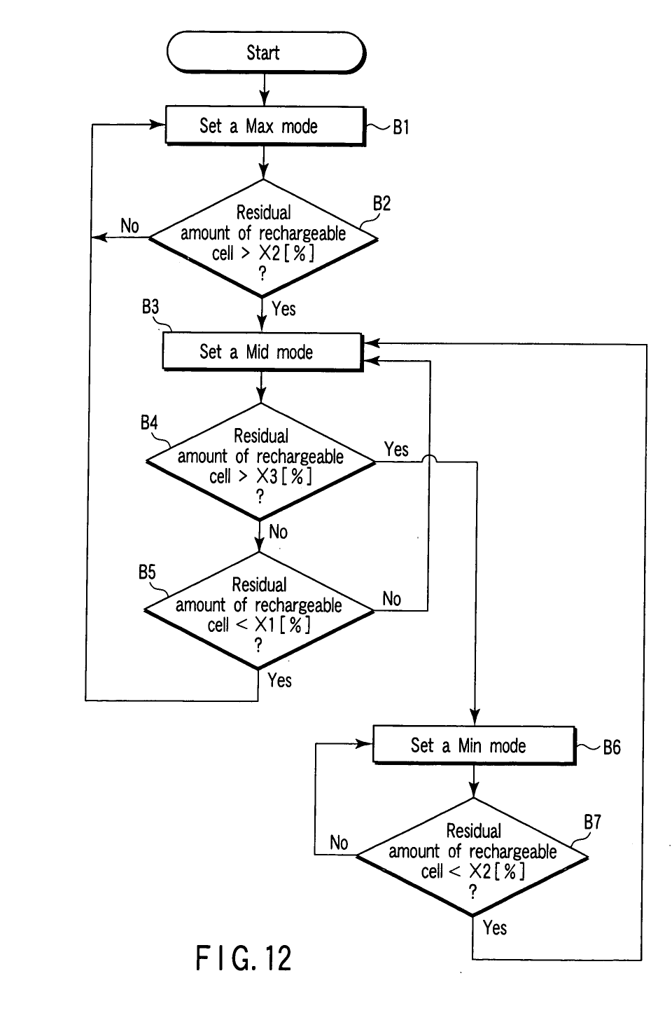

FIG. 12 is an exemplary flowchart showing an example of a control procedure of the DMFC 22 based on FIGS. 10 and 11. The microcomputer 21 controls the driving of the auxiliary machine 222 so as to set the DMFC 22 to the Max mode (operation B1) and checks whether or not the residual amount of the rechargeable cell 11 exceeds x2% (operation B2). If YES (YES in operation B2), the microcomputer 21 control the driving of the auxiliary machine 22 so as to set the DMFC 22 to the Mid mode (operation B3).

After the setting of the Mid mode, the microcomputer 21 checks whether or not the residual amount of the rechargeable cell 11 exceeds x3 or is lower than x1% (operation B4, operation B5). If YES (YES in operation B4), the microcomputer 21 controls the driving of the auxiliary machine 222 so as to set the DMFC 22 to the Min mode (operation B6). After the setting of the Min mode, the microcomputer 21 checks whether or not the residual amount of the rechargeable cell 11 in the electronic apparatus 1 becomes lower than x2% (operation B7). If YES (YES in operation B7), control goes back to operation B3 and the microcomputer controls the driving of the auxiliary machine 222 so as to set the DMFC 22 to the Mid mode.

After the setting of the Mid mode, the microcomputer checks whether or not the residual amount of the rechargeable cell 11 becomes lower than x1% (operation B5). If YES (YES in operation B5), control goes back to operation B1 and the microcomputer controls the driving of the auxiliary machine 222 so as to return the DMFC 22 to the Max mode.

Thus, in the electronic apparatus system of the present embodiment, it is possible to improve the operation efficiency of the DMFC 22 of the fuel cell unit 2 in cooperation with the rechargeable cell 11 of the electronic apparatus 1.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An electronic apparatus system comprising:
a rechargeable cell; and
a fuel cell unit including
a fuel cell; and
a control unit configured to adjust an amount of power generated by the fuel cell (i) from a first power generation amount to a second power generation amount, being less than the first power generation amount, when a residual amount of the rechargeable cell exceeds a first residual capacity level, and (ii) fro the second power generation amount to the first power generation amount when the residual amount of the rechargeable cell is reduced to a second residual capacity level being less than the first residual capacity level.

2. The electronic apparatus system according to claim 1, wherein the fuel cell unit further comprises a power converter coupled to the fuel cell and the rechargeable cell, and a charging circuit configured to charge the rechargeable cell when an amount of power produced by the power converter exceeds a level of power used by a load within the electronic apparatus system.

3. The electronic apparatus system according to claim 2, wherein the fuel cell unit further comprises a diode OR circuit including a first diode coupled to the rechargeable cell and a second diode coupled to the power converter and the charging circuit.

4. The electronic apparatus system according to claim 1, wherein the first power generation amount is above an average amount of power demanded and the second power generation amount is the average amount of power demanded.

5. The electronic apparatus system according to claim 2, wherein the control unit maintains an output voltage level by the power converter at a predetermined voltage when the charging circuit charges the rechargeable cell having the first residual capacity level and determines that the residual amount of the rechargeable cell exceeds the first residual capacity level when the output voltage level exceeds the predetermined voltage.

6. The electronic device system according to claim 2, wherein the control unit determines that the residual amount of the rechargeable cell has been reduced to the second residual capacity level if a predetermined time has elapsed after the power generation amount of the fuel cell is lowered from the first power generation amount to the second power generation amount.

7. The electronic apparatus system according to claim 1, wherein the control unit further adjusts an amount of power generated by the fuel cell (iii) from the second power generation amount to a third power generation amount being less than the second power generation amount when the residual amount of the rechargeable cell exceeds a third residual capacity level being greater than the first residual capacity level, and (iv) from the third power generation amount to the second power generation amount when the residual amount of the rechargeable cell becomes lower than the first residual capacity level.

8. A fuel cell unit attached to an electronic apparatus including a rechargeable cell, comprising:
a fuel cell; and
a control unit configured to adjust an amount of power generated by the fuel cell from a first power generation amount to a second power generation amount being less than the first power generation amount when a residual amount of the rechargeable cell exceeds a first residual capacity level, and to adjust the amount of power generated by the fuel cell from the second power generation amount to the first power generation amount when the residual amount of the rechargeable cell is lower than a second residual capacity level being less than the first residual capacity level.

9. The fuel cell unit according to claim 8, wherein the first power generation amount is above an average of demanded power by a load of the electronic apparatus and the second power generation amount is below the average of demanded power.

10. The fuel cell unit according to claim 8, further comprising an auxiliary machine; wherein the controller controls the auxiliary machine to adjust the amount of power generated by the fuel cell.

11. The fuel cell unit according to claim 8, further comprising a DC/DC converter coupled to the fuel cell and controlled by the control unit.

12. The fuel cell unit according to claim 10, wherein the control unit determines that the residual amount of the rechargeable cell has been reduced to the second residual capacity level when a predetermined time is elapsed after the amount of power generated by the fuel cell is lowered from the first power generation amount to the second power generation amount.

13. The fuel cell unit according to claim 8, wherein the control unit further adjusts the amount of power generated by the fuel cell from the second power generation amount to a third power generation amount being less than the second power generation amount when a residual amount of the rechargeable cell exceeds a third residual capacity level being greater than the first residual capacity level, and adjusts the amount of power generated by the fuel cell from the third power generation amount to the second power generation amount when a residual amount of the rechargeable cell is lower than the first residual capacity level.

14. A method for controlling a supply of power by a fuel cell unit equipped with a fuel cell, the fuel cell unit configured to connect to an electronic apparatus including a rechargeable cell, comprising:
controlling the fuel cell unit to adjust an amount of power generated by the fuel cell from a first power generation amount to a second power generation amount being less than the first power generation amount in response to a first condition based on a residual capacity of the rechargeable cell; and
controlling the fuel cell unit to adjust the amount of power generated by the fuel cell from the second power generation amount to the first power generation amount in response to a second condition based on the residual capacity of the rechargeable cell.

15. The method according to claim 14, wherein the first condition includes a state where the residual capacity of the rechargeable cell exceeds a first percentage of full capacity of the rechargeable cell.

16. The method according to claim 15, wherein the second condition includes a state where the residual capacity of the rechargeable cell exceeds a second percentage of full capacity of the rechargeable cell, the second percentage being less than the first percentage.

17. The method according to claim 15 further comprising:
controlling the fuel cell unit to adjust an amount of power generated by the fuel cell from the second power generation amount to a third power generation amount being less than the second power generation amount in response to a third condition based on the residual capacity of the rechargeable cell.

18. The method according to claim 17, wherein the third condition includes a state where the residual capacity of the rechargeable cell exceeds a second percentage of full capacity of the rechargeable cell being greater than the first percentage of full capacity.

19. The method according to claim 14, wherein the controlling the fuel cell unit comprises controlling an auxiliary machine in order to control output of the fuel cell supplied to a power converter of the fuel cell unit.

20. The method according to claim 19 further comprising using power supplied by the power converter to concurrently supply power to a load of the electronic apparatus and charge the rechargeable cell.
